(19) United States
(12) Patent Application Publication
(10) Pub. No.: US 2026/0119094 A1
(43) Pub. Date: Apr. 30, 2026

(54) COMPUTER PROGRAM PRODUCT, INFORMATION PROCESSING APPARATUS, AND CONTROL METHOD THEREOF FOR FACILITATING ESTABLISHMENT OF A WIRELESS CONNECTION

(71) Applicant: CANON KABUSHIKI KAISHA, Tokyo (JP)

(72) Inventor: RYO TAKABA, Kanagawa (JP)

(21) Appl. No.: 19/352,577

(22) Filed: Oct. 8, 2025

(30) Foreign Application Priority Data
Oct. 30, 2024 (JP) 2024-190613

(51) Int. Cl. G06F 3/12; H04W 48/20

(52) U.S. Cl. CPC G06F 3/1236; G06F 3/1205; G06F 3/1292; H04W 48/20

(57) ABSTRACT

An information processing apparatus performs direct wireless communication with a communication device to provide the communication device with connection information for connecting to an external access point. The information processing apparatus acquires state information of the communication device from the communication device through the direct wireless communication. The information processing apparatus switches guidance for establishing a wireless connection with the communication device via the external access point based on the state information. A first screen is displayed on the display of the information processing apparatus when the state information indicates a predetermined state. A second screen is displayed on the display when the state information does not indicate the predetermined state. The first screen leads to a screen providing a method for clearing the predetermined state. The second screen leads to a screen providing a method for establishing a wireless connection between the external access point and the communication device.

### BACKGROUND

### Field of the Technology

The present disclosure relates to a computer program product, an information processing apparatus, and a method of controlling the information processing apparatus.

### DESCRIPTION OF THE RELATED ART

In order to enable the use of a purchased printing device (hereinafter referred to as “printer”) from an information processing apparatus such as a personal computer (PC), a user first installs a setup application on the information processing apparatus. Next, the user performs setup operations for the printer using the setup application installed on the information processing apparatus. The setup operations include establishing a network connection for the printer, installing a driver on the information processing apparatus, and obtaining usage permissions required to use the printer with various web services.

For example, when the information processing apparatus performs setup to establish a wireless connection with a communication device such as a printer via an external access point (hereinafter referred to as “AP”), the setup may fail due to factors such as the communication environment or user errors in the procedure. In such cases, the setup application displays guidance to assist the user in successfully completing the setup. Japanese Patent Application Laid-Open No. 2024-076634 discloses related technology. In this conventional technology, when a connection between the communication device and the AP is not successfully established, information for connecting the communication device to the AP is displayed on a display of the information processing apparatus.

There may be multiple possible causes for the failure to establish a connection between the communication device and the AP. If guidance corresponding to each of the possible causes is displayed, the user has to independently determine which piece of guidance provides the appropriate solution. In such a configuration, where the user is required to select the appropriate guidance on their own, they are burdened with identifying the correct guidance, and if the user selects inappropriate guidance, it may result in failure to establish a wireless connection with the communication device via the AP.

### SUMMARY

Embodiments described herein are directed to technology capable of increasing the success rate of establishing a wireless connection with a communication device via an AP, while reducing the burden on a user in searching for appropriate guidance.

In one embodiment, a computer program product includes a non-transitory computer-readable medium having stored thereon computer-executable instructions for an information processing apparatus configured to communicate with a communication device. The computer-executable instructions, when executed by a processor of the information processing apparatus, cause the information processing apparatus to perform a control method. The control method includes: performing direct wireless communication with the communication device to provide the communication device with connection information for connecting to an external access point; acquiring state information of the communication device from the communication device through the direct wireless communication; and switching guidance for establishing a wireless connection with the communication device via the external access point based on the state information of the communication device. A first screen is displayed on the display of the information processing apparatus when the state information of the communication device indicates a predetermined state. A second screen is displayed on the display of the information processing apparatus when the state information of the communication device does not indicate the predetermined state. The first screen leads to a screen providing a method for clearing the predetermined state. The second screen leads to a screen providing a method for establishing a wireless connection between the external access point and the communication device.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an overall configuration of a system including a PC as an information processing apparatus according to a first embodiment.

FIG. 2 is a flowchart illustrating the procedure of a printer setup control process performed by a setup application of the PC illustrated in FIG. 1.

FIG. 3 is a flowchart illustrating the procedure of a wireless connection process in step S207 of FIG. 2.

FIG. 4 is a flowchart illustrating the procedure of a communication control process performed by the printer illustrated in FIG. 1.

FIGS. 5A to 5G are diagrams each illustrating an example of a screen displayed on a display of the PC illustrated in FIG. 1.

FIGS. 6A and 6B are diagrams each illustrating an example of a screen displayed on a display of the printer illustrated in FIG. 1.

FIG. 7 is a flowchart illustrating the procedure of a printer setup control process performed by a setup application of a PC according to a second embodiment.

FIG. 8 is a diagram illustrating an example of a manual transition confirmation screen displayed on a display of the PC according to the second embodiment.

FIGS. 9A and 9B are diagrams each illustrating an example of a screen displayed on a display of a printer according to the second embodiment.

### DESCRIPTION OF THE EMBODIMENTS

Example embodiments will be described with reference to the accompanying drawings. It should be noted that the following embodiments are provided for illustrative purposes only and are not intended to limit the scope of the disclosure.

First, a description will be given of an information processing apparatus and a control method thereof according to a first embodiment.

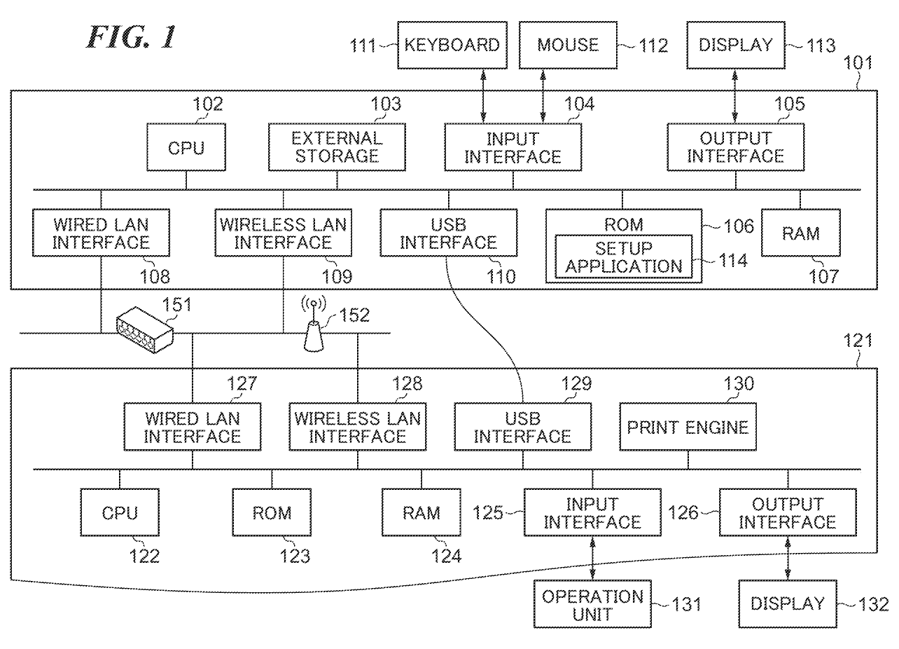

FIG. 1 is a diagram illustrating an overall configuration of a system including a PC 101 as an information processing apparatus according to the first embodiment.

As illustrated in FIG. 1, the PC 101 includes a CPU 102, an external storage 103, an input interface 104, an output interface 105, a ROM 106, and a RAM 107. The PC 101 also includes a wired LAN interface 108, a wireless LAN interface 109, and a USB interface 110. A keyboard 111 and a mouse 112 are connected to the input interface 104, and a display 113 is connected to the output interface 105. The ROM 106 stores a setup application 114 used for setting up a printer 121. Examples of setup operations for the printer 121 include establishing a network connection for the printer 121, installing a driver on the PC 101 to enable the printer 121 to perform printing, and obtaining usage permissions required to use the printer 121 with various web services. Hereinafter, the setup operations for the printer 121 may also be referred to as a connection setup process. The setup application 114 is loaded from the ROM 106 into the RAM 107 for execution.

The printer 121 includes a CPU 122, a ROM 123, a RAM 124, an input interface 125, an output interface 126, a wired LAN interface 127, a wireless LAN interface 128, a USB interface 129, and a print engine 130. An operation unit 131 is connected to the input interface 125, and a display 132 is connected to the output interface 126.

The PC 101 and the printer 121 are connected via their respective interfaces so that they can communicate with each other. A typical example of such interfaces includes the USB interface 110 of the PC 101 and the USB interface 129 of the printer 121. In this case, the USB interface 110 and the USB interface 129 are connected via a USB cable. The interfaces may be connected directly using a single USB cable, or indirectly via a USB hub (not illustrated) using two USB cables.

The wired LAN interface 108 of the PC 101 is connected to the wired LAN interface 127 of the printer 121 via a router 151. The wireless LAN interface 109 of the PC 101 is connected to the wireless LAN interface 128 of the printer 121 via an access point (AP) 152. When the router 151 and the AP 152 are on the same network, communication between the wired LAN and the wireless LAN is also possible. Accordingly, for example, the wired LAN interface 108 of the PC 101 may be connected to the wireless LAN interface 128 of the printer 121, or the wireless LAN interface 109 of the PC 101 may be connected to the wired LAN interface 127 of the printer 121. The router 151 and the AP 152 are connected to the Internet, and the PC 101 and the printer 121 can each access the Internet via their respective wired or wireless LAN interfaces. As communication methods between the PC 101 and the printer 121, three types of interfaces, i.e., wired LAN, wireless LAN, and USB, have been described. However, the PC 101 and the printer 121 need not necessarily include all three types of interfaces; it is sufficient for them to be equipped with any one of these interfaces.

### Direct Connection Method

The term “direct connection” refers to a form of wireless connection in which devices connect directly to each other (i.e., peer-to-peer) without via an external device such as the AP 152. The direct connection is also referred to as a wireless peer-to-peer (P2P) connection. The printer 121 is capable of operating in a mode for communicating via a direct connection (direct connection mode) as one of its connection modes. In Wi-Fi communication, there are a plurality of modes for communicating via a direct connection, such as a software AP mode and a Wi-Fi Direct (WFD) mode.

A mode in which a direct connection is established using Wi-Fi Direct is referred to as the WFD mode. Wi-Fi Direct is a standard defined by the Wi-Fi Alliance and is part of the IEEE 802.11 series of communication standards. In the WFD mode, after a peer device is discovered through a device discovery command, the roles of P2P group owner (GO) and P2P client are determined, followed by the remaining wireless connection processes. The group owner corresponds to the parent station (access point) in Wi-Fi, and the client corresponds to the child station (client device). This role determination corresponds, for example, to GO Negotiation in P2P. In the WFD mode, before the role determination is completed, the printer 121 is in a state where it is neither a parent station nor a child station.

Specifically, between devices that perform communication, one device first issues a device discovery command to search for another device to connect with in the WFD mode. When the communication partner device is discovered, both devices check information regarding the services and functions available from each other. This service/function information check is optional and not mandatory. This information check phase corresponds, for example, to provision discovery in P2P. Next, by mutually checking the service/function information, the devices determine which one will act as the P2P client and which one will act as the P2P group owner. Once the client and the group owner are determined, the devices exchange parameters necessary for communication using Wi-Fi Direct. The P2P client and group owner perform the remaining wireless connection processes and IP connection processes based on the exchanged parameters. In the WFD mode, the printer 121 may always operate as the group owner without performing the aforementioned GO Negotiation. In other words, the printer 121 may operate in the WFD mode as an Autonomous GO mode. The state in which the printer 121 is operating in the WFD mode includes, for example, a state where a WFD connection has not yet been established but the printer 121 is operating as the group owner, or a state where a WFD connection has already been established and the printer 121 is operating as the group owner.

In the software AP mode, between devices that perform communication (e.g., the PC 101 and the printer 121), one device (e.g., the PC 101) serves as a client that requests various services. The other device implements the functions of an AP in Wi-Fi through software configuration. The software AP corresponds to the parent station in Wi-Fi, and the client corresponds to the child station. In the software AP mode, the client searches for a device to serve as a software AP using a device discovery command. Once the software AP is discovered, the client and the software AP perform the remaining wireless connection processes (e.g., establishing a wireless connection) and then perform the IP connection processes (e.g., IP address assignment). Note that the commands and parameters transmitted and received to establish a wireless connection between the client and the software AP may be those defined in the Wi-Fi standard, and thus a detailed description thereof is omitted herein.

In this embodiment, when the printer 121 has established and is maintaining a direct connection, it operates as a parent station in the network to which it belongs. The parent station is a device that establishes a wireless network and provides parameters used for connecting to the wireless network to a child station. The parameters used for connecting to the wireless network include, for example, parameters related to the channel used by the parent station. The child station receives such parameters and connects to the wireless network established by the parent station using the channel used by the parent station. In the direct connection mode, since the printer 121 operates as the parent station, the printer 121 can determine which frequency band and which channel to use for communication in the direct connection mode. In this embodiment, the printer 121 is assumed to be capable of using channels corresponding to the 2.4 GHz frequency band and channels corresponding to the 5 GHz frequency band for communication in the direct connection mode.

### Infrastructure Connection Method

The term “infrastructure connection” refers to a form of connection in which devices that perform communication (e.g., the PC 101 and the printer 121) connect to an AP (e.g., the AP 152) that manages the network, and they communicate with each other through the AP. The printer 121 is capable of operating in a mode for communicating via an infrastructure connection (infrastructure connection mode) as one of its connection modes.

In an infrastructure connection, each device searches for an AP using a device discovery command. Once the AP is discovered, the device and the AP perform the remaining wireless connection processes (e.g., establishing a wireless connection) and then perform the IP connection processes (e.g., IP address assignment). Note that the commands and parameters transmitted and received to establish a wireless connection between the device and the AP may be those defined in the Wi-Fi standard, and thus a detailed description thereof is omitted herein.

In this embodiment, when the printer 121 operates in an infrastructure connection, the AP 152 functions as the parent station, and the printer 121 functions as the child station. That is, in this embodiment, the infrastructure connection refers to a connection between the printer 121 functioning as a child station and a device functioning as a parent station. When the printer 121 has established an infrastructure connection and the PC 101 has also established an infrastructure connection with the AP 152, communication between the printer 121 and the PC 101 becomes possible via the AP 152. Since the channel used for communication in the infrastructure connection is determined by the AP 152, the printer 121 performs communication in the infrastructure connection using the channel determined by the AP 152. In this embodiment, the printer 121 is assumed to be capable of using channels corresponding to the 2.4 GHz frequency band and channels corresponding to the 5 GHz frequency band for communication in the infrastructure connection. Additionally, the printer 121 may also use channels corresponding to the dynamic frequency selection (DFS) band within the 5 GHz frequency band for communication in the infrastructure connection. In order to communicate with the printer 121 via the AP 152, the PC 101 recognizes and identifies that the printer 121 belongs to the network formed by the AP 152, to which the PC 101 also belongs.

### Connection Setup Process

In this embodiment, the PC 101 performs a connection setup (network setup), which is a setting for enabling the printer 121 to operate using at least one of the communication methods, i.e., the infrastructure connection or the direct connection, through wireless communication with the printer 121. Since the connection setup process in this embodiment is performed via wireless communication, it is also referred to as cableless setup (CLS). Note that the connection setup process may also be performed via wired communication. The PC 101 performs the connection setup process to the printer 121 when the setup application 114, which is stored in the external storage 103 or the like, is running. The printer 121 is capable of operating in a wireless setup mode (connection setup state), which is a mode for performing the connection setup process, and performs the connection setup process while operating in the wireless setup mode. Details of the wireless setup mode will be described later.

When causing the printer 121 to operate in the infrastructure connection mode, the PC 101 wirelessly transmits infrastructure setting information, which is setting information for enabling operation in the infrastructure connection mode, to the printer 121. The infrastructure setting information includes information related to the AP 152. The information related to the AP 152 may include, for example, a service set identifier (SSID), a password, and information related to the frequency band.

On the other hand, when causing the printer 121 to operate in the direct connection mode, the PC 101 wirelessly transmits direct setting information, which is setting information for enabling operation in the direct connection mode, to the printer 121. The direct setting information includes instructions to enable the WFD function and to cause the printer 121 to operate as a group owner, or to enable the access point settings of the printer 121. In addition, the PC 101 acquires, from the printer 121, connection information for establishing a direct connection with the printer 121. The connection information for establishing a direct connection with the printer 121 includes, for example, the SSID and password of the printer 121 operating in the direct connection mode.

In this embodiment, a direct connection for connection setup between the PC 101 and the printer 121 is used to transmit the infrastructure setting information and direct setting information and to acquire the information for establishing a direct connection with the printer 121 in the connection setup process. In this embodiment, the connection setup process is performed using Wi-Fi as the direct connection for connection setup; however, wireless communication standards other than Wi-Fi, such as Bluetooth, may alternatively be used. Additionally, wired communication standards, such as wired LAN or universal serial bus (USB) may also be used as the direct connection for connection setup.

After an infrastructure connection or a direct connection via Wi-Fi is established between the PC 101 and the printer 121 through the connection setup process, communication between the PC 101 and the printer 121 becomes possible via the established connection. Specifically, for example, the PC 101 can transmit a print job to cause the printer 121 to perform printing, or a scan job to cause the printer 121 to perform scanning, to the printer 121 via the established connection. In this embodiment, the connection setup process allows the printer 121 to operate in the infrastructure connection mode as well as in the direct connection mode; however, the embodiment is not limited thereto. For example, the connection setup process may be configured to allow the printer 121 to operate only in the infrastructure connection mode (i.e., it cannot cause the printer 121 to operate in the direct connection mode).

### Wireless Setup Mode

The printer 121 is capable of operating in the wireless setup mode. A trigger for the printer 121 to start operating in the wireless setup mode may be, for example, a user pressing a button for the wireless setup mode or the printer 121 being powered on for the first time after delivery. The button for the wireless setup mode may be a hardware (physical) button provided on the printer 121, or a software button displayed on the display 132 of the printer 121.

When the printer 121 starts operating in the wireless setup mode, both Wi-Fi communication and Bluetooth low energy (BLE) communication are enabled. Specifically, as a process of enabling Wi-Fi communication, the printer 121 enables an internal AP (connection setup AP) dedicated to the wireless setup mode. As a result, the printer 121 becomes capable of establishing a direct Wi-Fi connection with the PC 101. At least part of the connection information (such as an SSID) for connecting to the connection setup AP is pre-stored in the setup application 114 installed on the PC 101. In other words, the PC 101 is assumed to have prior knowledge of at least part of the connection information for connecting to the connection setup AP.

Specifically, the SSID of the connection setup AP is a unique SSID assigned to each printer 121, including a common character string shared among multiple printers and an individual character string that differs for each printer. The information pre-stored in the setup application 114 is assumed to be the common character string in the SSID of the connection setup AP. Unlike the connection information for the AP enabled in the direct connection mode, the connection information for connecting to the connection setup AP is not allowed to be arbitrarily changed by the user. Note that the connection setup AP may be configured without an encryption method, and connection to the AP may not require a password. Furthermore, in the wireless setup mode, the printer 121 may connect to the PC 101 using Wi-Fi Direct instead of standard Wi-Fi. In other words, the printer 121 may operate as a group owner and receive a setup command from the PC 101 via WFD communication. Additionally, in cases where the printer 121 does not have a BLE communication function, the printer 121 may enable only Wi-Fi communication when operating in the wireless setup mode.

### Registration of Communication Device to Application

In this embodiment, the setup application 114 can register the printer 121 therein by acquiring information related to the printer 121 from the printer 121. The information related to the printer 121 may include, for example, capability information of the printer 121, identification information of the printer 121 (such as a MAC address), and model information of the printer 121. The capability information of the printer 121 specifically includes, for example, a list of information on functions supported by the printer 121, information on consumables (e.g., ink and paper) usable in the printer 121, and information indicating the printing method employed by the printer 121. The setup application 114 selects one device, from among one or more printers 121 registered in the setup application 114, as a partner device for communication through the setup application 114. Hereinafter, the printer 121 currently selected as the partner device for communication through the setup application 114 is referred to as the “selected printer 121.”

The selection of the partner device for communication through the setup application 114 may be performed by receiving a user selection from among one or more printers 121 registered in the setup application 114, or it may alternatively be performed automatically by the setup application 114 in accordance with a predetermined criterion. In addition, the change of the partner device for communication through the setup application 114 may also be performed, for example, by receiving a user selection from among one or more printers 121 registered in the setup application 114. In this embodiment, the setup application 114 transmits various jobs, such as print jobs and scan jobs, to the selected printer 121. In other words, the selected printer 121 is the device that serves as the transmission destination for various jobs.

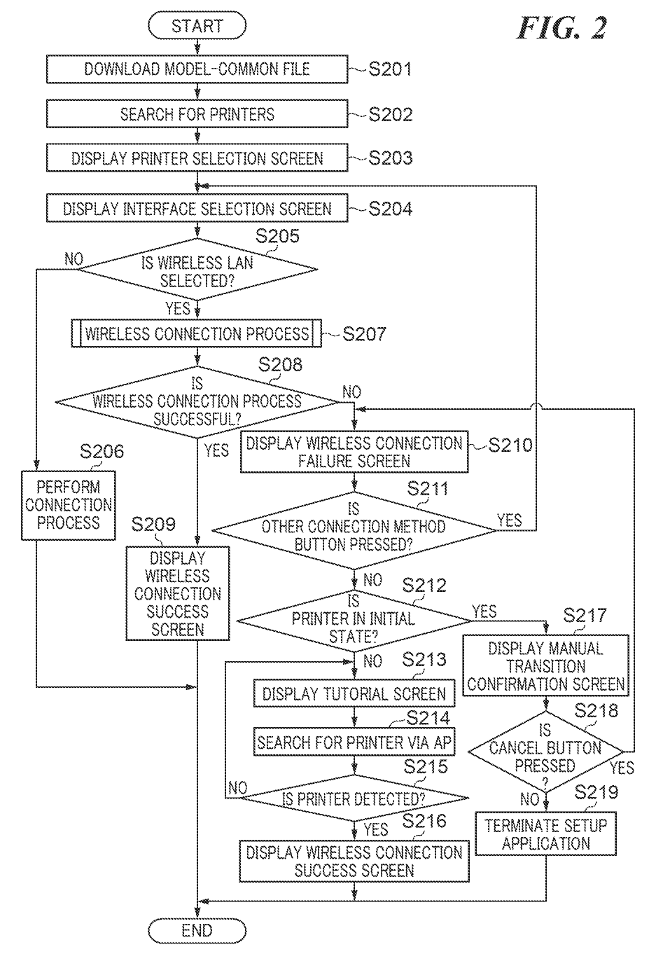

FIG. 2 is a flowchart illustrating the procedure of a setup control process for the printer 121 performed by the setup application 114 of the PC 101 illustrated in FIG. 1. The setup control process is initiated when the executable file of the setup application 114 is opened by the user.

In FIG. 2, first, in step S201, the setup application 114 downloads a model-common file related to the printer 121. Specifically, the setup application 114 downloads a file that is commonly required in the subsequent processes regardless of the printer model. This file is, for example, a content file that the setup application 114 uses when performing a test print.

Next, in step S202, the setup application 114 searches for printers via the wireless LAN interface 109. Specifically, the setup application 114 acquires identification information from printers operating as APs. The identification information includes, for example, the device name of each printer.

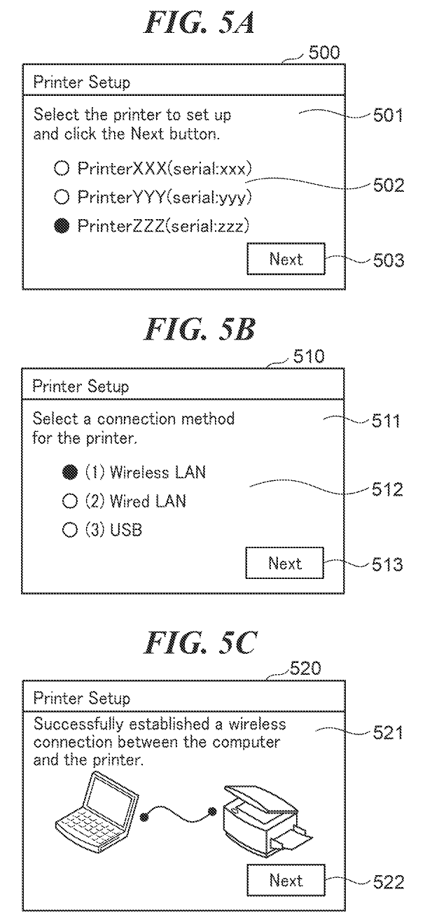

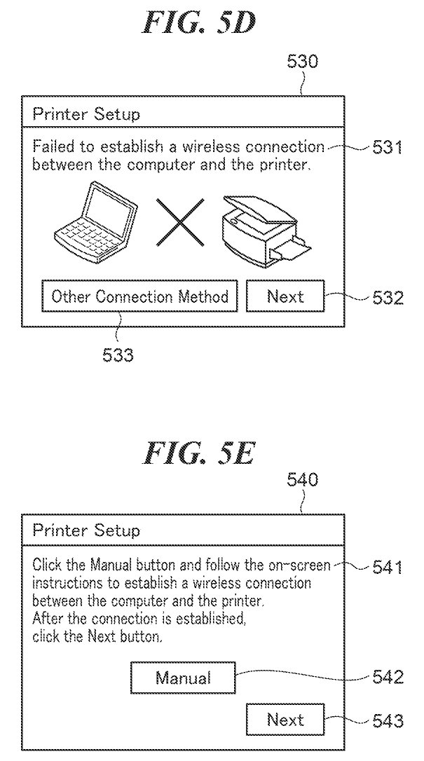

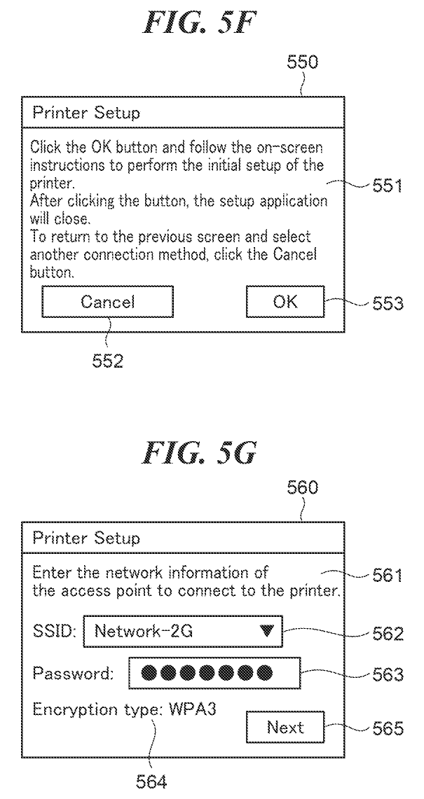

In step S203, the setup application 114 displays a printer selection screen 500, as illustrated in FIG. 5A, on the display 113. The printer selection screen 500 includes a printer selection message 501, printer selection radio buttons 502, and a “Next” button 503. The printer selection message 501 is a message prompting the user to select a printer using the printer selection radio buttons 502 and then press (click) the “Next” button 503. The printer selection radio buttons 502 represent a list of the printers detected in step S202. The user selects one printer from this list. When the setup application 114 detects that the user has selected one of the printers through the printer selection radio buttons 502 and pressed the “Next” button 503, it closes the printer selection screen 500, and the process proceeds to step S204. In this embodiment, it is assumed that the printer 121 is selected on the printer selection screen 500.

In step S204, the setup application 114 displays an interface selection screen 510, as illustrated in FIG. 5B, on the display 113. The interface selection screen 510 is used to select a connection method with the printer 121 and includes an interface selection message 511, interface selection radio buttons 512, and a “Next” button 513. The interface selection message 511 is a message prompting the user to select a connection method for the printer. The interface selection radio buttons 512 represent a list of interfaces available for connecting the printer 121 to the PC 101. The user selects one interface from this list. When the setup application 114 detects that the user has selected one of the interfaces through the interface selection radio buttons 512 and pressed the “Next” button 513, it closes the interface selection screen 510, and the process proceeds to step S205.

In step S205, the setup application 114 determines whether a wireless LAN has been selected on the interface selection screen 510. If it is determined that a wireless LAN has been selected on the interface selection screen 510, the process proceeds to step S207 (described later). If it is determined that a wireless LAN has not been selected on the interface selection screen 510, i.e., if a wired LAN or USB has been selected on the interface selection screen 510, the process proceeds to step S206.

In step S206, the setup application 114 performs a connection process. In the connection process, the PC 101 is connected to the printer 121 using the interface selected on the interface selection screen 510 (i.e., the wired LAN interface 108 or the USB interface 110). Thereafter, the process ends. If the connection process is successful, a connection success screen including a message indicating the success of the connection process may be displayed on the display 113. If the connection process fails, a connection failure screen including a message indicating the failure of the connection process may be displayed on the display 113.

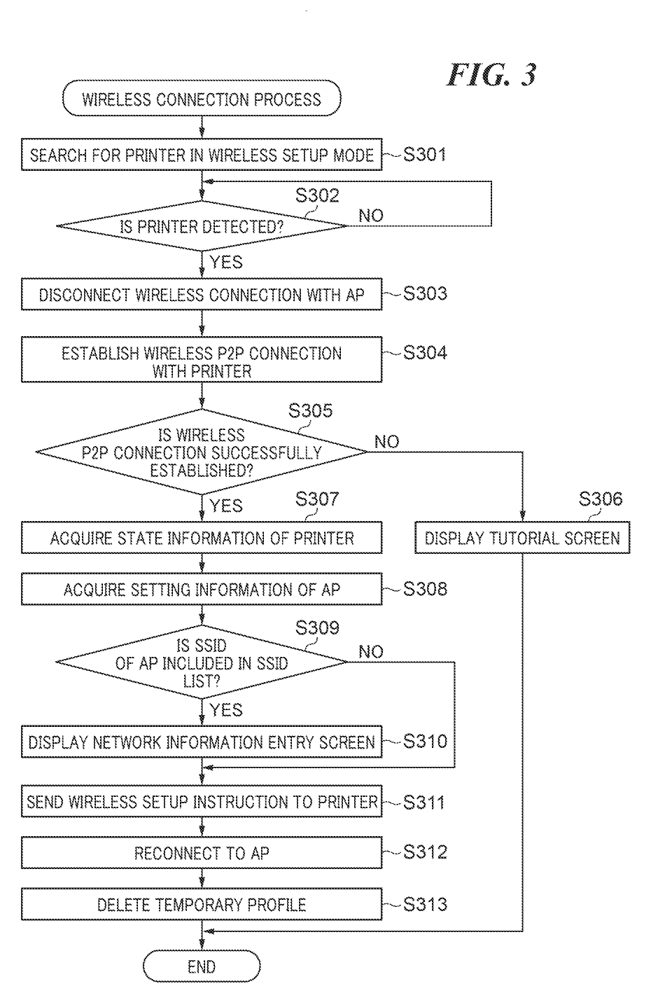

In step S207, the setup application 114 performs a wireless connection process, described below with reference to FIG. 3. As a result, the PC 101 establishes a wireless connection with the printer 121 using the wireless LAN interface 109.

Next, in step S208, the setup application 114 determines whether the wireless connection process in step S207 has succeeded. This determination may be made, for example, based on whether the setup application 114 has been able to detect the printer 121 on the network via the AP 152 during its network search. Alternatively, the determination may be made based on whether a failure has been recorded in any of the steps of the wireless connection process in step S207. If it is determined that the wireless connection process in step S207 has failed, the process proceeds to step S210 (described later). If it is determined that the wireless connection process in step S207 has succeeded, the process proceeds to step S209.

In step S209, the setup application 114 displays a wireless connection success screen 520, as illustrated in FIG. 5C, on the display 113. The wireless connection success screen 520 includes a wireless connection success message 521 and a “Next” button 522. The wireless connection success message 521 is a message indicating that the wireless connection with the printer 121 has been successfully established. When the setup application 114 detects that the user has pressed the “Next” button 522, it closes the wireless connection success screen 520, and the process ends.

In step S210, the setup application 114 displays a wireless connection failure screen 530 (third screen), as illustrated in FIG. 5D, on the display 113. The wireless connection failure screen 530 includes a wireless connection failure message 531, a “Next” button 532, and an “Other Connection Method” button 533. The wireless connection failure message 531 is a message indicating that the wireless connection with the printer 121 has failed. The “Next” button 532 is an object used to display guidance for establishing a wireless connection between the AP 152 and the printer 121. The “Other Connection Method” button 533 is an object used to display the interface selection screen 510 on the display 113. When the setup application 114 detects that the user has pressed either the “Next” button 532 or the “Other Connection Method” button 533, it closes the wireless connection failure screen 530, and the process proceeds to step S211.

In step S211, the setup application 114 determines whether the “Other Connection Method” button 533 has been pressed on the wireless connection failure screen 530. If it is determined that the “Other Connection Method” button 533 has been pressed on the wireless connection failure screen 530, the process returns to step S204. If it is determined that the “Other Connection Method” button 533 has not been pressed on the wireless connection failure screen 530, i.e., if the “Next” button 532 has been pressed on the wireless connection failure screen 530, the process proceeds to step S212.

In step S212, the setup application 114 determines whether the printer 121 is in a predetermined state based on the state information of the printer 121 acquired from the printer 121 during the wireless connection process in step S207. Specifically, the setup application 114 determines whether the printer 121 is in its initial state based on the state information of the printer 121. In this embodiment, the initial state refers to a state in which the components of the printer 121 are secured with tape or the like, and no ink tank is installed in the printer 121. In the printer 121, unless the initial state is cleared, the user cannot perform operations such as setting up a wireless connection. Therefore, in order to establish a wireless connection with the printer 121 via the AP 152, the initial state needs to be cleared first.

In this embodiment, control is performed to switch the guidance for establishing a wireless connection with the printer 121 via the AP 152, based on the determination result of step S212. For example, if the state information of the printer 121 indicates that the printer 121 is in its initial state, it is determined in step S212 that the printer 121 is in the initial state. In this case, to display a screen providing measures to clear the initial state as the guidance, the process proceeds to step S217 (described later). On the other hand, if the state information of the printer 121 does not indicate that the printer 121 is in its initial state, or if the state information could not be acquired from the printer 121 during the wireless connection process in step S207, it is determined that the printer 121 is not in the initial state. In such cases, to display a screen providing a method for establishing a wireless connection between the printer 121 and the AP 152 as the guidance, the process proceeds to step S213. In this manner, in this embodiment, the guidance for establishing a wireless connection with the printer 121 via the AP 152 is switched depending on whether the printer 121 is in its initial state.

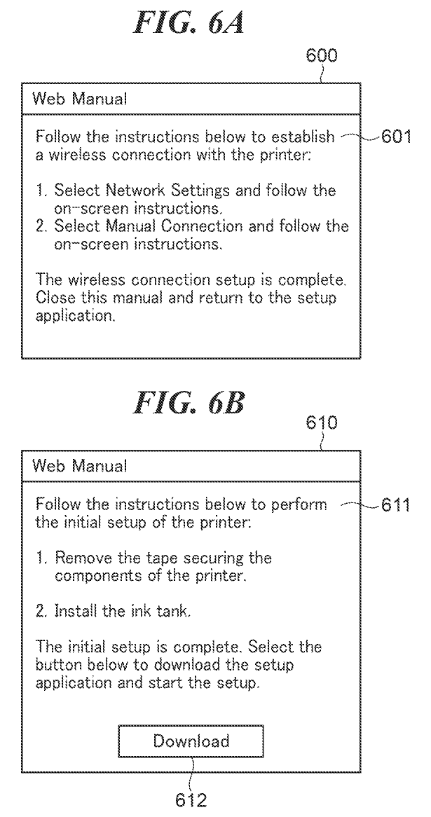

In step S213, the setup application 114 displays a tutorial screen 540 (second screen), as illustrated in FIG. 5E, on the display 113. The tutorial screen 540 is a screen that leads to a wireless connection tutorial screen 600 illustrated in FIG. 6A (described later), and includes a tutorial message 541, a “Manual” button 542, and a “Next” button 543. The tutorial message 541 is a message prompting the user to press (click) the “Manual” button 542 to display guidance and perform wireless connection setup. When the setup application 114 detects that the user has pressed the “Manual” button 542 on the tutorial screen 540, it displays a web page on the display 132 of the printer 121 using a web browser (not illustrated). Specifically, the setup application 114 displays the wireless connection tutorial screen 600, as illustrated in FIG. 6A, on the display 132 of the printer 121 through the web browser.

The wireless connection tutorial screen 600 is a screen that provides a method for establishing a wireless connection between the AP 152 and the printer 121, and includes wireless connection guidance 601. The wireless connection guidance 601 provides instructions on how to operate the operation unit 131 of the printer 121 to establish a wireless connection between the printer 121 and the AP 152. The instructions also include how to operate the printer 121 to switch it into a wireless setup mode (described later). The wireless connection guidance 601 may further include instructions on how to clear the initial state if the printer 121 is in the initial state. The user sets up the wireless connection by operating the operation unit 131 of the printer 121 in accordance with the wireless connection guidance 601.

When the setup application 114 detects that the user has pressed the “Next” button 543 on the tutorial screen 540 displayed on the display 113 of the PC 101, it closes the wireless connection tutorial screen 600, and the process proceeds to step S214.

In step S214, the setup application 114 searches for the printer 121 on the network via the AP 152.

Next, in step S215, the setup application 114 determines whether the printer 121 has been detected in step S214. If it is determined that the printer 121 has not been detected, the process returns to step S213. If it is determined that the printer 121 has been detected, the process proceeds to step S216.

In step S216, the setup application 114 displays the wireless connection success screen 520 on the display 113. Thereafter, the process ends.

In step S217, the setup application 114 displays a manual transition confirmation screen 550 (first screen), as illustrated in FIG. 5F, on the display 113. The manual transition confirmation screen 550 is a screen that leads to an initial state guidance screen 610 illustrated in FIG. 6B (described later), and includes a manual transition confirmation message 551, a “Cancel” button 552, and an “OK” button 553. The manual transition confirmation message 551 is a message prompting the user to press (click) the “OK” button 553 and perform the initial setup process of the printer 121 in accordance with the displayed guidance. The manual transition confirmation message 551 also includes instructions on how to change the printer’s connection method to another connection method. The “Cancel” button 552 is an object used to display the wireless connection failure screen 530 on the display 113. The “OK” button 553 is an object used to display the initial state guidance screen 610 illustrated in FIG. 6B (described later) on the display 132 of the printer 121. When the user presses either the “OK” button 553 or the “Cancel” button 552 on the manual transition confirmation screen 550, the process proceeds to step S218.

In step S218, the setup application 114 determines whether the “Cancel” button 552 has been pressed on the manual transition confirmation screen 550. If it is determined that the “Cancel” button 552 has been pressed on the manual transition confirmation screen 550, the process returns to step S210. If it is determined that the “Cancel” button 552 has not been pressed on the manual transition confirmation screen 550, i.e., if the “OK” button 553 has been pressed, the setup application 114 displays a web page on the display 132 of the printer 121 using a web browser. Specifically, the setup application 114 displays the initial state guidance screen 610, as illustrated in FIG. 6B, on the display 132 of the printer 121 through the web browser.

The initial state guidance screen 610 is a screen that provides a method for clearing the initial state of the printer 121 and includes an initial state guidance 611 and a “Download” button 612. The initial state guidance 611 indicates the procedures to be performed on the printer 121 in its initial state. Examples of such procedures include removing tape or similar materials used to secure printer components, installing an ink tank, connecting the power cord, and pressing the power button. The initial state guidance 611 also includes a message prompting the user to re-download the setup application 114 after completing the initial setup process.

In this embodiment, the initial state guidance 611 is described as including a message prompting the user to re-download the setup application 114 after completing the initial setup process; however, it is not limited thereto. For example, instead of such a message, the initial state guidance 611 may include a message prompting the user to execute the setup application 114 stored in the ROM 106. When the “Download” button 612 is pressed by the user, the PC 101 downloads the setup application 114. After the download is completed, the user launches the setup application 114, and the setup control process illustrated in FIG. 2 is performed again.

When the “OK” button 553 is pressed on the manual transition confirmation screen 550, the setup application 114 terminates its operation (S219). Thereafter, the process ends.

Note that although the predetermined state has been described as the initial state in the setup control process illustrated in FIG. 2, the predetermined state is not limited to the initial state and may be any state in which operations such as wireless connection setup cannot be performed. For example, the predetermined state may be a state in which it is impossible to display a home screen that allows a transition to a wireless connection settings screen. In addition, the predetermined state may be a state in which the program of the printer 121 cannot receive a request to establish a wireless connection with the PC 101 via the AP 152.

FIG. 3 is a flowchart illustrating the procedure of the wireless connection process in step S207 of FIG. 2.

In FIG. 3, first, in step S301, the setup application 114 searches for the printer 121 in the wireless setup mode. As described above, the printer 121 in the wireless setup mode operates as an AP with a unique SSID assigned. In step S301, the setup application 114 searches for this SSID.

Next, in step S302, the setup application 114 determines whether the printer 121 has been detected in step S301. Specifically, the setup application 114 determines whether the unique SSID assigned to the printer 121 operating as an AP has been detected. If it is determined that the printer 121 has not been detected, the process repeats step S302. If it is determined that the printer 121 has been detected, the process proceeds to step S303.

In step S303, the setup application 114 disconnects the wireless connection with the AP 152. Subsequently, in step S304, the setup application 114 establishes a wireless P2P connection with the printer 121. Specifically, the PC 101 connects the wireless LAN interface 109 to the printer 121, which operates as an AP with a unique SSID assigned.

Next, in step S305, the setup application 114 determines whether the wireless P2P connection with the printer 121 has been successfully established. If it is determined that the wireless P2P connection with the printer 121 has been successful, the process proceeds to step S307 (described later). If it is determined that the wireless P2P connection with the printer 121 has failed, the process proceeds to step S306.

In step S306, the setup application 114 displays the tutorial screen 540 on the display 113. The configuration of the tutorial screen 540 is as described above in the explanation of step S213. Thereafter, the process ends.

In step S307, the setup application 114 acquires the state information of the printer 121 from the printer 121. Specifically, the setup application 114 sends a state information acquisition request to the printer 121 and, in response, receives the state information of the printer 121 from the printer 121. The state information of the printer 121 includes information indicating whether the printer 121 is in its initial state, as well as an SSID list. The SSID list is a list of SSIDs corresponding to APs detected by the printer 121.

In step S308, the setup application 114 refers to the wireless profiles and connection destination information stored in the PC 101 to acquire the setting information (including the SSID) of the AP 152, with which it disconnected the wireless connection in step S303.

Next, in step S309, the setup application 114 determines whether the SSID of the AP 152 is included in the SSID list acquired in step S307. If it is determined that the SSID of the AP 152 is included in the SSID list, the process proceeds to step S310. If it is determined that the SSID of the AP 152 is not included in the SSID list, the process proceeds to step S311 (described later).

In step S310, the setup application 114 displays a network information entry screen 560, as illustrated in FIG. 5G, on the display 113. The network information entry screen 560 includes an entry message 561, an SSID drop-down list 562, a password entry field 563, an encryption method display section 564, and a “Next” button 565. The entry message 561 is a message prompting the user to enter information on the AP to be connected to the printer 121. The SSID drop-down list 562 lists the information from the SSID list acquired in step S307. The password entry field 563 is a field for entering the password required to connect to the selected SSID. The encryption method display section 564 displays supplementary information for the SSID selected from the SSID drop-down list 562, namely, the encryption method information acquired from the printer 121. When the setup application 114 detects that the user has pressed the “Next” button 565, it closes the network information entry screen 560, and the process proceeds to step S311.

In step S311, the setup application 114 sends a wireless setup instruction to the printer 121 via wireless P2P. Specifically, the setup application 114 sends (provides) the setting information (connection information) of the AP 152, including the SSID and password, to the printer 121.

Next, in step S312, the setup application 114 reconnects the PC 101 to the AP 152. In step S312, if the wireless profile of the AP 152 is stored in the ROM 106 of the PC 101, the setup application 114 can reconnect the PC 101 to the AP 152 without requiring the user to re-enter a password or other information. Alternatively, if no encryption method is set for the AP 152, the setup application 114 can reconnect the PC 101 to the AP 152 by specifying the SSID of the AP 152, without requiring the user to re-enter a password or other information.

In step S313, if a wireless profile (referred to as a “temporary profile” in FIG. 3) generated as a result of the temporary wireless P2P connection remains, the setup application 114 deletes the wireless profile. This step is performed to prevent a wireless profile for an unintended connection from remaining. Upon completion of step S313, the process ends.

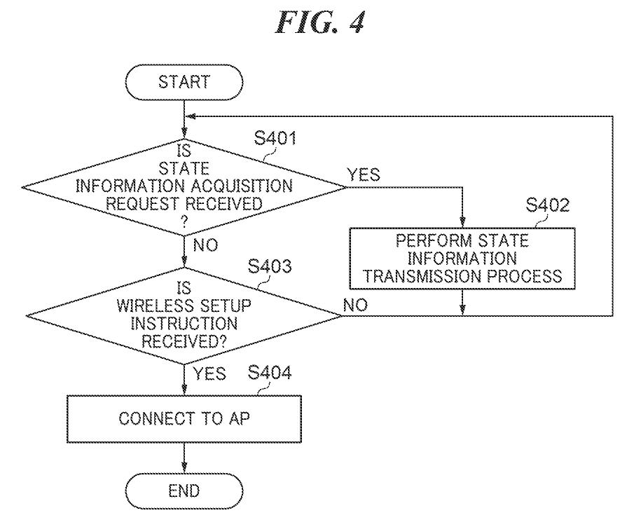

FIG. 4 is a flowchart illustrating the procedure of a communication control process performed by the printer 121 illustrated in FIG. 1. The communication control process is performed when the printer 121 transitions to the wireless setup mode. The printer 121 enters the wireless setup mode, for example, when it is powered on for the first time after purchase or when the user performs a specific input operation. In the wireless setup mode, the printer 121 operates as an AP with a unique SSID assigned.

In FIG. 4, first, in step S401, the printer 121 determines whether it has received a state information acquisition request from the PC 101. If the printer 121 has not received a state information acquisition request from the PC 101, the process proceeds to step S403 (described later). If the printer 121 has received a state information acquisition request from the PC 101, the process proceeds to step S402.

In step S402, the printer 121 performs a state information transmission process in response to the received state information acquisition request. Specifically, the printer 121 transmits to the PC 101 state information that includes information indicating whether the printer 121 is in its initial state and an SSID list. The SSID list may be created by searching for surrounding APs after receiving the state information acquisition request, or it may be created when the printer 121 transitions to the wireless setup mode. Upon completion of step S402, the process returns to step S401.

In step S403, the printer 121 determines whether it has received a wireless setup instruction from the PC 101. If it is determined that a wireless setup instruction has not been received, the process returns to step S401. If it is determined that a wireless setup instruction has been received, the process proceeds to step S404.

In step S404, the printer 121 performs a connection process to the AP 152 specified by the PC 101. Specifically, the printer 121 uses the SSID and password included in the wireless profile received from the PC 101 to perform the connection process to the AP 152. Thereafter, the process ends.

According to the first embodiment described above, the guidance for establishing a wireless connection with the printer 121 via the AP 152 is switched based on whether the printer 121 is in its initial state. This reduces the burden on the user in searching for appropriate guidance. In addition, the user can be prevented from selecting inappropriate guidance, thereby increasing the success rate of establishing a wireless connection with the printer 121 via the AP 152.

In the first embodiment described above, when the printer 121 is in the initial state, the manual transition confirmation screen 550, which leads to the initial state guidance screen 610 providing a method for clearing the initial state, is displayed on the display 113. Conversely, when the printer is not in the initial state, the tutorial screen 540, which leads to the wireless connection tutorial screen 600 providing a method for establishing a wireless connection between the AP 152 and the printer 121, is displayed on the display 113. This allows appropriate guidance to be presented to the user according to whether the printer 121 is in the initial state.

Additionally, in the first embodiment described above, when a wireless P2P connection with the printer 121 fails, the tutorial screen 540 is displayed on the display 113, which leads to the wireless connection tutorial screen 600 including instructions on how to operate the printer 121 to switch it to the wireless setup mode. This allows the user to be presented with an operation method for successfully establishing a wireless P2P connection with the printer 121 in the event of a failed wireless P2P connection.

Furthermore, in the first embodiment described above, the manual transition confirmation screen 550 includes the “OK” button 553, which is an object used to display the initial state guidance screen 610 on the display 132 of the printer 121. As a result, when the printer 121 is in the initial state, the user can be presented with the initial state guidance screen 610 that provides instructions on how to clear the initial state.

In the first embodiment described above, the manual transition confirmation screen 550 includes the “Cancel” button 552, which is an object used to display the wireless connection failure screen 530 including the “Other Connection Method” button 533 on the display 113. This allows the user to select a connection method other than wireless LAN for connecting the PC 101 and the printer 121 when the printer is not in the initial state.

Next, a description will be given of an information processing apparatus and a control method thereof according to a second embodiment.

The second embodiment is substantially the same as the first embodiment described above in terms of configuration and operation; however, it differs from the first embodiment in that the guidance is switched based on which of a plurality of steps for clearing the initial state of the printer 121 have been completed. Therefore, explanations of similar configurations and operations will not be repeated below, and only those that differ will be described.

There are a plurality of steps for clearing the initial state of the printer 121. In the second embodiment, it is assumed that the printer 121 is configured to generate an initial state clearing stage that includes information capable of identifying the steps that have been completed among all the steps for clearing the initial state of the printer 121. The initial state clearing stage includes information capable of identifying the completed steps, such as a first stage, a second stage, and a third stage. The first stage corresponds, for example, to a state in which none of the steps for clearing the initial state of the printer 121 have been performed. The second stage corresponds, for example, to a state in which, among the steps for clearing the initial state of the printer 121, the removal of tape or the like securing the components of the printer 121 has been completed. The third stage corresponds, for example, to a state in which, among the steps for clearing the initial state of the printer 121, the removal of tape or the like securing the components of the printer 121 and the installation of an ink tank in the printer 121 have been completed.

In such a configuration, the state information of the printer 121 exchanged in steps S307 and S402 described above includes, in addition to the aforementioned information, the error state of the printer 121 and the initial state clearing stage. For example, the printer 121 determines whether the removal of tape or the like securing the components of the printer 121 has been performed using a sensor located around the components of the printer 121 and reflects the determination result in the initial state clearing stage. In addition, the printer 121 determines whether an ink tank has been installed in the printer 121 using a sensor located around an ink tank installation area of the printer 121 and reflects the determination result in the initial state clearing stage.

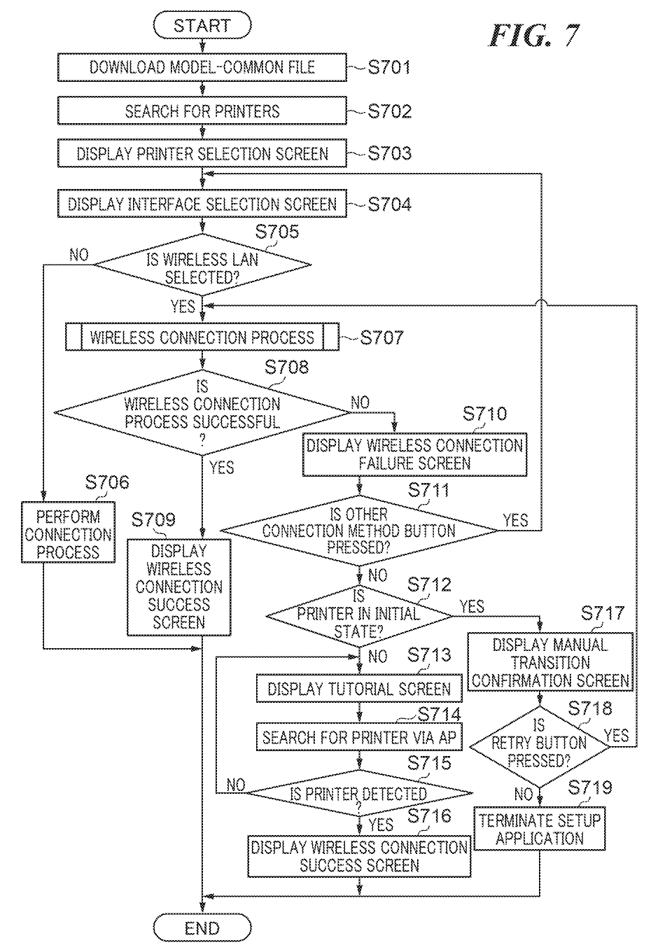

FIG. 7 is a flowchart illustrating the procedure of a setup control process for the printer 121 performed by the setup application 114 of the PC 101 according to the second embodiment. The setup control process of FIG. 7 is similar to the setup control process of FIG. 2 described above, and the following description focuses specifically on aspects that differ from the setup control process of FIG. 2. Similar to the setup control process of FIG. 2 described above, the setup control process of FIG. 7 is initiated when the executable file of the setup application 114 is opened by the user.

In FIG. 7, steps S701 to S712 are performed in the same manner as steps S201 to S212 described above, respectively.

In step S712, if it is determined that the printer 121 is not in the initial state, the process proceeds to step S713. If it is determined that the printer 121 is in the initial state, the process proceeds to step S717.

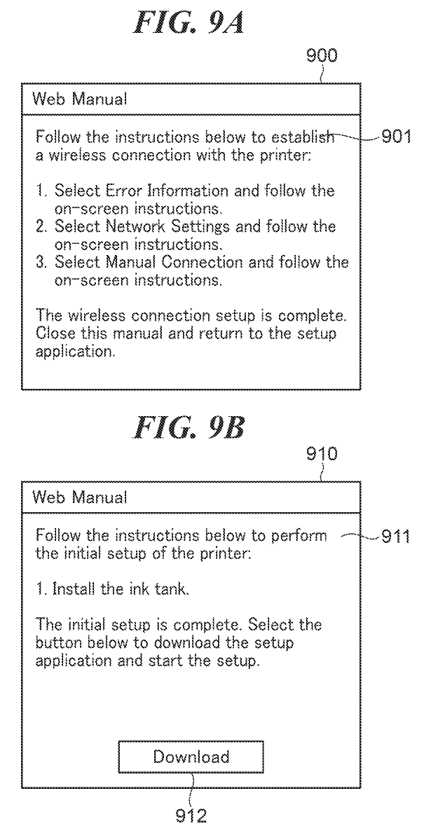

In step S713, the setup application 114, as in step S213 described above, displays the tutorial screen 540 on the display 113. In the second embodiment, when the “Manual” button 542 is pressed by the user, the setup application 114 displays a web page on the display 132 of the printer 121 using a web browser; however, the content of the web page differs from that in the first embodiment described above. Specifically, if it is determined that the printer 121 is in an error state based on the state information of the printer 121 received in step S707, a wireless connection tutorial screen 900, as illustrated in FIG. 9A, is displayed on the display 132 of the printer 121. On the other hand, if it is determined that the printer 121 is not in an error state based on the state information of the printer 121 received in step S707, the wireless connection tutorial screen 600 described above is displayed on the display 132 of the printer 121.

The wireless connection tutorial screen 900 includes wireless connection guidance 901. The wireless connection guidance 901 provides instructions not only on how to operate the operation unit 131 of the printer 121 to establish a wireless connection, but also on how to clear the error state. The wireless connection guidance 901 may further include instructions on how to clear the initial state if the printer 121 is in the initial state. Thereafter, steps S714 to S716 are performed in the same manner as steps S214 to S216 described above, respectively, and the process ends.

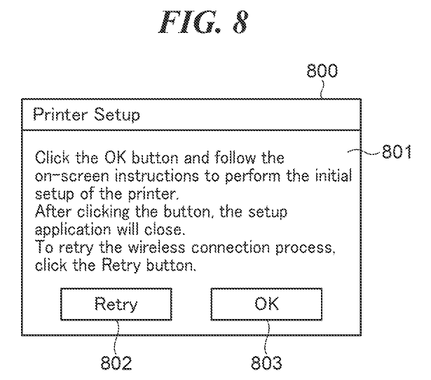

In step S717, the setup application 114 displays a manual transition confirmation screen 800, as illustrated in FIG. 8, on the display 113. The manual transition confirmation screen 800 is a screen that leads to an initial state guidance screen 910 illustrated in FIG. 9B (described later), and includes a manual transition confirmation message 801, a “Retry” button 802, and an “OK” button 803. The manual transition confirmation message 801 is a message prompting the user to press (click) the “OK” button 803 and perform the initial setup process of the printer 121 in accordance with the displayed guidance. The manual transition confirmation message 801 also includes a message indicating an operation method for retrying the wireless connection process. The “Retry” button 802 is an object used to instruct the retry of the wireless connection process. The “OK” button 803 is an object used to display the initial state guidance screen 910, described below with reference to FIG. 9B, on the display 132 of the printer 121. When the user presses either the “Retry” button 802 or the “OK” button 803 on the manual transition confirmation screen 800, the process proceeds to step S718.

In step S718, the setup application 114 determines whether the “Retry” button 802 has been pressed on the manual transition confirmation screen 800. If it is determined that the “Retry” button 802 has been pressed on the manual transition confirmation screen 800, the process returns to step S707. If it is determined that the “Retry” button 802 has not been pressed on the manual transition confirmation screen 800, i.e., if the “OK” button 803 has been pressed, the setup application 114 displays a web page on the display 132 of the printer 121 using a web browser. Specifically, if the initial state clearing stage identified from the state information of the printer 121 received in step S707 indicates the first stage, the setup application 114 displays the initial state guidance screen 610 described above on the display 132 of the printer 121.

When the initial state clearing stage indicates the first stage, as described above, none of the steps for clearing the initial state of the printer 121 have yet been performed. In this case, the initial state guidance screen 610 displayed on the display 132 of the printer 121 includes guidance on all of the steps for clearing the initial state of the printer 121. On the other hand, if the initial state clearing stage identified from the state information of the printer 121 received in step S707 indicates the second or third stage, an initial state guidance screen is displayed that does not include guidance on steps that have already been completed. For example, if the initial state clearing stage identified from the state information of the printer 121 received in step S707 indicates the second stage, the setup application 114 displays the initial state guidance screen 910, as illustrated in FIG. 9B, on the display 132 of the printer 121. When the initial state clearing stage is the second stage, as described above, among the steps for clearing the initial state of the printer 121, the removal of tape or the like securing the components of the printer 121 has already been completed.

The initial state guidance screen 910 includes an initial state guidance 911 and a “Download” button 912. The initial state guidance 911 indicates the procedures to be performed on the printer 121 in its initial state. Unlike the initial state guidance 611 on the initial state guidance screen 610 described above, the initial state guidance 911 does not include guidance on steps that have already been completed, specifically, guidance on the removal of tape or the like securing the components of the printer 121. Meanwhile, the initial state guidance 911 includes a message prompting the user to re-download the setup application 114 after completing the initial setup process. In the second embodiment, the initial state guidance 911 is described as including a message prompting the user to re-download the setup application 114 after completing the initial setup process; however, it is not limited thereto. For example, instead of such a message, the initial state guidance 911 may include guidance for executing the setup application 114 stored in the ROM 106. When the “Download” button 912 is pressed by the user, the PC 101 downloads the setup application 114. After the download is completed, the user launches the setup application 114, and the setup control process illustrated in FIG. 7 is performed again.

When the “OK” button 803 is pressed on the manual transition confirmation screen 800, the setup application 114 terminates its operation (S719). Thereafter, the process ends.

According to the second embodiment described above, the guidance for establishing a wireless connection with the printer 121 via the AP 152 is switched based on the initial state clearing stage. This enables the user to be presented with an initial state guidance screen that does not include instructions related to steps already completed among all the steps for clearing the initial state of the printer 121. As a result, the success rate of establishing a wireless connection with the printer 121 via the AP 152 can be further increased.

In addition, in the second embodiment described above, the guidance for establishing a wireless connection with the printer 121 via the AP 152 is switched based on the error state. This allows the user to be presented with guidance appropriate for the error state of the printer 121.

Furthermore, in the second embodiment described above, the manual transition confirmation screen 800 includes the “Retry” button 802, which is an object used to instruct the retry of the wireless connection process. This enables the user to instruct the retry of the wireless connection process when the establishment of a wireless connection with the printer 121 via the AP 152 fails.

According to the embodiments described above, it is possible to increase the success rate of establishing a wireless connection with a communication device via an AP, while reducing the burden on a user in searching for appropriate guidance.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

The functions of the above-described embodiments need not be realized solely by a computer reading out and executing one or more programs. Part or all of the actual processing may be performed by an operating system or the like running on the computer based on the instructions of the program(s), thereby realizing the functions of the above embodiments.

Furthermore, the program(s) read out of the storage medium may be written to a memory provided in a function expansion board inserted into the computer or a function expansion unit connected to the computer, and the CPU or the like in the function expansion board or function expansion unit may perform part or all of the actual processing based on the instructions of the program(s), thereby realizing the functions of the above embodiments.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-190613, filed October 30, 2024, which is hereby incorporated by reference herein in its entirety.

What is claimed is:

1. A computer program product comprising a non-transitory computer-readable medium having computer-executable instructions stored thereon that, when executed by a processor of an information processing apparatus, cause the information processing apparatus to perform a method comprising:
performing direct wireless communication with a communication device to provide the communication device with connection information for connecting to an external access point;
acquiring state information of the communication device from the communication device through the direct wireless communication;
switching guidance for establishing a wireless connection with the communication device via the external access point based on the state information of the communication device;
displaying, on a display of the information processing apparatus, a first screen that leads to a screen providing a method for clearing a predetermined state when the state information of the communication device indicates the predetermined state; and
displaying, on the display of the information processing apparatus, a second screen that leads to a screen providing a method for establishing a wireless connection between the external access point and the communication device when the state information of the communication device does not indicate the predetermined state.

2. The computer program product according to claim 1, wherein
the screen providing a method for establishing a wireless connection with the communication device provides a method for causing the communication device to transition into a mode for performing the direct wireless communication, and
when the direct wireless communication with the communication device fails, the second screen is displayed on the display of the information processing apparatus.

3. The computer program product according to claim 1, wherein the first screen includes an object to display the screen providing a method for clearing the predetermined state on the display of the communication device.

4. The computer program product according to claim 1, wherein
the first screen includes an object to display a third screen on the display of the information processing apparatus, and
the third screen includes another object to display a screen for selecting a method of connecting to the communication device on the display of the information processing apparatus.

5. The computer program product according to claim 1, wherein the first screen includes an object to instruct retry of a wireless connection process for establishing a wireless connection with the communication device via the external access point.

6. The computer program product according to claim 1, wherein
the state information of the communication device includes information indicating an error state of the communication device, and
the guidance for establishing a wireless connection with the communication device via the external access point is switched based on the error state of the communication device.

7. The computer program product according to claim 1, wherein
a plurality of steps are required to clear the predetermined state,
the state information of the communication device includes identifiable information capable of identifying steps that have already been completed among the steps required to clear the predetermined state, and
the guidance for establishing a wireless connection with the communication device via the external access point is switched based on the identifiable information.

8. The computer program product according to claim 1, wherein the predetermined state is an initial state of the communication device.

9. The computer program product according to claim 1, wherein the predetermined state is a state in which the communication device is unable to receive a request to establish a wireless connection with the information processing apparatus via the external access point.

10. The computer program product according to claim 1, wherein the communication device is a printer.

11. An information processing apparatus configured to communicate with a communication device, the apparatus comprising processing circuitry configured to:
perform direct wireless communication with the communication device to provide the communication device with connection information for connecting to an external access point;
acquire state information of the communication device from the communication device through the direct wireless communication;
switch guidance for establishing a wireless connection with the communication device via the external access point based on the state information of the communication device;
display, on a display, a first screen that leads to a screen providing a method for clearing a predetermined state when the state information of the communication device indicates the predetermined state; and
display, on the display, a second screen that leads to a screen providing a method for establishing a wireless connection between the external access point and the communication device when the state information of the communication device does not indicate the predetermined state.

12. A method of controlling an information processing apparatus configured to communicate with a communication device, the method comprising:
performing direct wireless communication with the communication device to provide the communication device with connection information for connecting to an external access point;
acquiring state information of the communication device from the communication device through the direct wireless communication;
switching guidance for establishing a wireless connection with the communication device via the external access point based on the state information of the communication device;
displaying, on a display of the information processing apparatus, a first screen that leads to a screen providing a method for clearing a predetermined state when the state information of the communication device indicates the predetermined state; and
displaying, on the display of the information processing apparatus, a second screen that leads to a screen providing a method for establishing a wireless connection between the external access point and the communication device when the state information of the communication device does not indicate the predetermined state.
